(19) United States
(12) Patent Application Publication
(10) Pub. No.: US 2012/0089776 A1
(43) Pub. Date: Apr. 12, 2012

(54) SYSTEMS AND METHODS FOR RAID METADATA STORAGE

(75) Inventors: Alex Grossman, Lomita, CA (US); Jordan Woods, Redondo Beach, CA (US); Salvador Munar, Redondo Beach, CA (US); John L. Bertagnolli, Parker, CO (US); Marty S. Levens, Dripping Springs, TX (US); Edwin M. Wynne, Pinckney, MI (US)

(73) Assignee: ACTIVE STORAGE, INC., Torrance, CA (US)

(21) Appl. No.: 13/084,444

(22) Filed: Apr. 11, 2011

Related U.S. Application Data
(60) Provisional application No. 61/322,909, filed on Apr. 11, 2010.

(51) Int. Cl. G06F 12/08

(52) U.S. Cl. 711/114; 711/E12.019

(57) ABSTRACT

Systems and methods for providing self-contained embedded storage providing data redundancy and automatic failover for a RAID system are disclosed. In one embodiment, a metadata RAID array module disposed for insertion in a metadata controller is disclosed. The array module may be configured to receive power and/or cooling from the metadata controller while providing RAID metadata functionality through an external interface. The external interface may be a Fibre channel interface.

### CROSS-REFERENCE TO RELATED APPLICATIONS

This application claims priority under 35 U.S.C. §119(e) to U.S. Provisional Patent Application Ser. No. 61/322,909, entitled SYSTEMS AND METHODS FOR RAID METADATA STORAGE, filed Apr. 11, 2011, the contents of which is incorporated by reference herein in its entirety for all purposes.

### FIELD OF THE INVENTION

This application is directed generally to Redundant Array of Independent Disks (“RAID”) storage and the use of such storage as storage area networks (“SANs”). More particularly, but not exclusively, the present application is directed to systems and methods to facilitate self-contained embedded storage providing data redundancy and automatic failover.

### BACKGROUND OF THE INVENTION

In RAID storage systems, metadata RAID arrays are typically configured as high performance external storage devices. These external storage devices use high speed interfaces—e.g., interface technology associated with Fibre Channel or other networking technologies—and are coupled via a corresponding switch—e.g., a Fibre Channel switch or other switch.

Metadata servers are typically used in RAID storage systems. Such metadata servers use metadata to keep track of file system information, pool size, and other housekeeping storage. Typical external storage devices have used very large hard drives that must be mirrored, resulting in inefficient consumption of RAID storage resources. For example, mirrored data in typical systems will reserve the entire capacity of four 1 terabyte (TB) drives for only 1 gigabyte (GB) of data.

Such standard configurations as those described above have resulted in many disadvantages, including inefficient use of storage resources and high cost associated with use expensive drives for metadata storage.

### SUMMARY OF THE INVENTION

Exemplary embodiments of the invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In accordance with some aspects of the present invention, configurable storage and processing modules, such as those in the form of computer “cards”, may be inserted in or placed in communication with a metadata controller or other computing device to dynamically store metadata that would otherwise be stored on costly Redundant Array of Independent Disks (“RAID”) storage within a storage area network (“SAN”). The metadata may then be mirrored from one metadata module/card to another metadata module/card associated with the same metadata controller/computing device or another metadata controller/computing device in order to ensure redundant storage of the metadata. This approach advantageously frees up valuable space within the RAID storage of the SAN as well as bandwidth of the storage controller which would otherwise be consumed in interfacing with the RAID storage for metadata communication.

In one aspect, the invention provides a system comprising a frame configured for insertion in a host device, and an electronics module coupled to the frame. The electronics module may include a host bus interface configured to receive power from the host device, one or more storage devices, an external communications interface configured to provide access to the storage devices from a client computer through an external communications network, and controller electronics configured to manage the host bus interface, the one or more storage devices and the external communications interface.

In another aspect, the invention provides a method for managing storage for a RAID system. Such a method may receive, at a metadata controller, a request from a client computer for access to data on a RAID array. The metadata controller may then retrieve, from a metadata RAID array module associated with the metadata controller, metadata associated with the client computer request. The metadata controller may then provide the metadata to the client computer of another device.

In another aspect, the invention provides a method for managing storage for a system using RAID storage of data. Such a method may employ a metadata RAID array module associated with a metadata controller, where the RAID array module receives power from a host device (e.g., the metadata controller or other device), receives a request for metadata via an external communications interface, and provides one or more sets of metadata from a storage device disposed in the metadata RAID array module responsive to the request for metadata.

### BRIEF DESCRIPTION OF THE DRAWINGS

The features, nature, and advantages of the present disclosure will become more apparent from the detailed description set forth below when taken in conjunction with the drawings in which like reference characters identify conespondingly throughout and wherein:

FIG. 1 illustrates an example RAID storage system;

FIG. 2A illustrates a RAID storage system in accordance with aspects of the present invention;

FIG. 2B illustrates details of metadata RAID array modules and inter-connection in accordance with aspects of the present invention;

FIG. 3 illustrates details of elements of a metadata RAID array module in accordance with aspects of the present invention;

FIG. 4 depicts a process flow diagram that illustrates minoring operations;

FIG. 5 depicts a process flow diagram that illustrates failover operations;

FIG. 6 illustrates an embodiment of a metadata server with incorporated Card in accordance with aspects of the present invention.

### DETAILED DESCRIPTION

Various aspects of embodiments are described below, and it should be apparent that the teachings herein may be implemented in a wide variety of forms and that any specific structure, function, or both being disclosed herein is merely representative. Various embodiments may be implemented in the form of processes and methods, apparatuses and devices, systems, and/or computer-readable media.

Systems that use RAID storage offer a high volume of storage capacity, and redundant storage of data. One example of a RAID system is a storage area network or SAN. SANs provide a storage mechanism where one or more client computers connect via a storage protocol (e.g., the standardized Fibre Channel technology). In these systems, client computers are unaware where storage is physically located. A server or controller communicates with each of the client computers, and the client computers can then mount a file system locally to access remote storage via the operating system of the client computer.

The disclosure relates generally to systems and methods for providing self-contained embedded storage providing data redundancy and automatic failover. In one embodiment, a metadata Redundant Array of Independent Disks (“RAID”) array module disposed for insertion in a metadata controller or other computing device is described. The RAID array module may be configured to receive power and/or cooling from the metadata controller while providing RAID metadata functionality via an external interface. The external interface may be a Fibre Channel interface or other suitable technology.

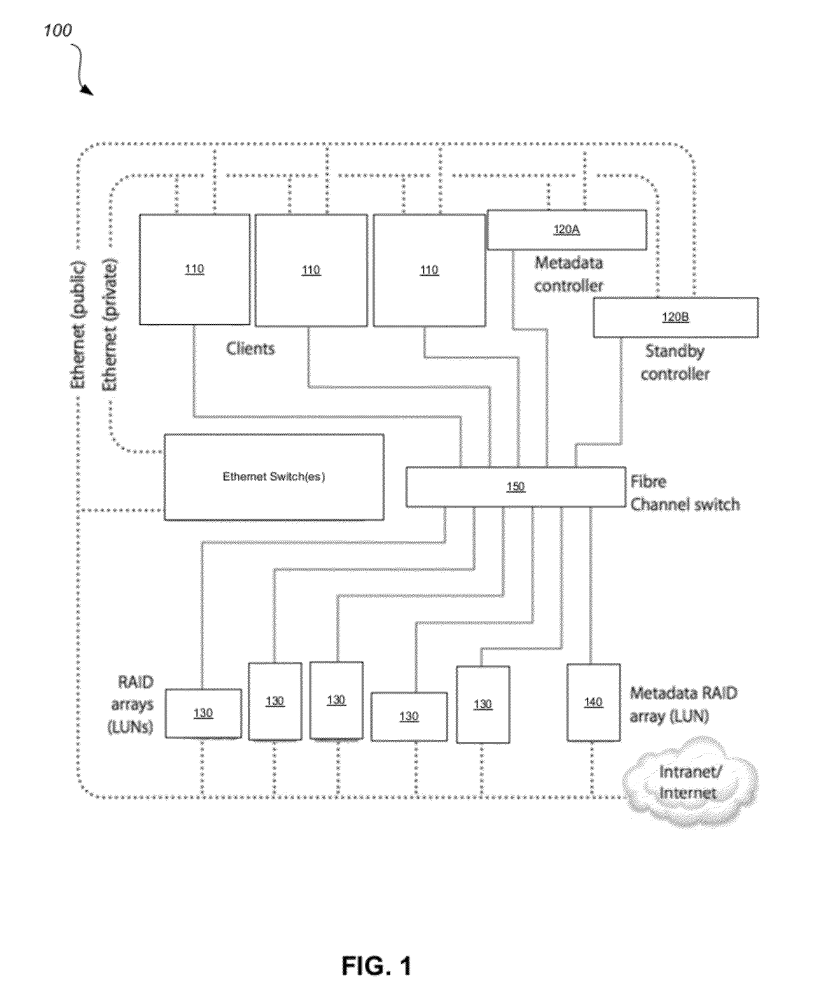

For purposes of comparison, a typical RAID storage system 100 is shown in FIG. 1. In this configuration, a set of clients 110 are configured to access high capacity external storage on a set of RAID arrays 130. The clients are typically configured so that access to the external storage is essentially transparent—i.e., the clients see the external storage as another drive on their system drive mapping, and the data is transferred to and from the external storage RAID in a transparent fashion from the client 100's perspective. In order to facilitate this external drive management, metadata controllers 120 are typically used. As shown in FIG. 1, these are normally configured with a primary controller 120A, as well as a standby or backup controller 120B. These controllers 120A and 120B are configured to mirror content between each of the storage volumes on the external storage RAID associated with each other to provide seamless failover in the event of a failure of the primary controller 120A. The configuration shown in FIG. 1, however, is expensive and inefficient in use of storage space within the external storage RAID.

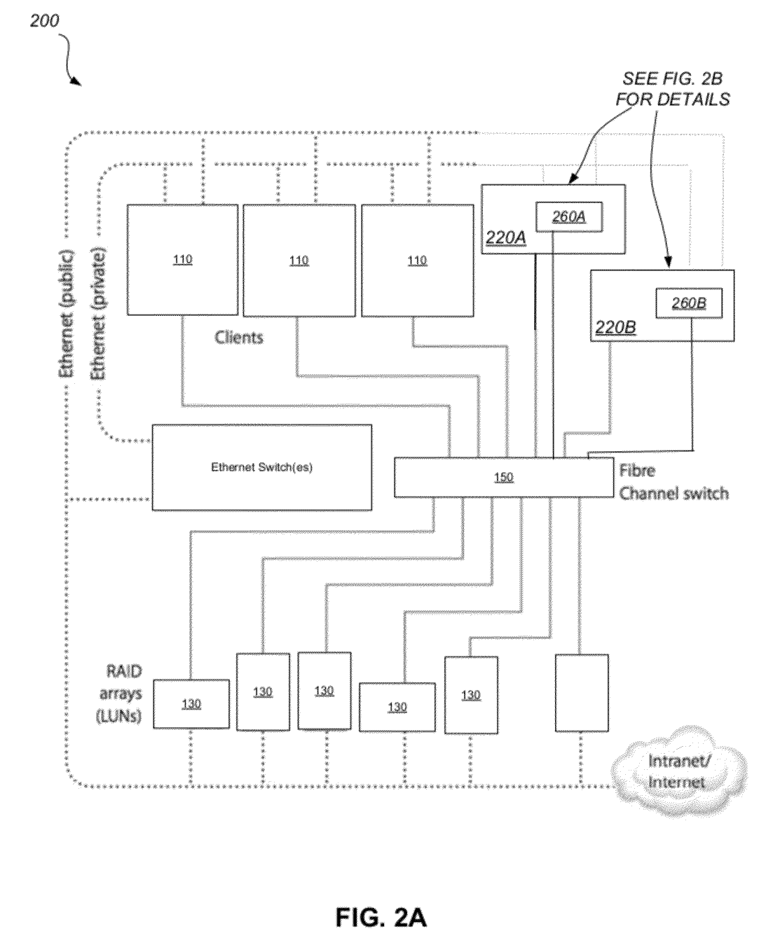

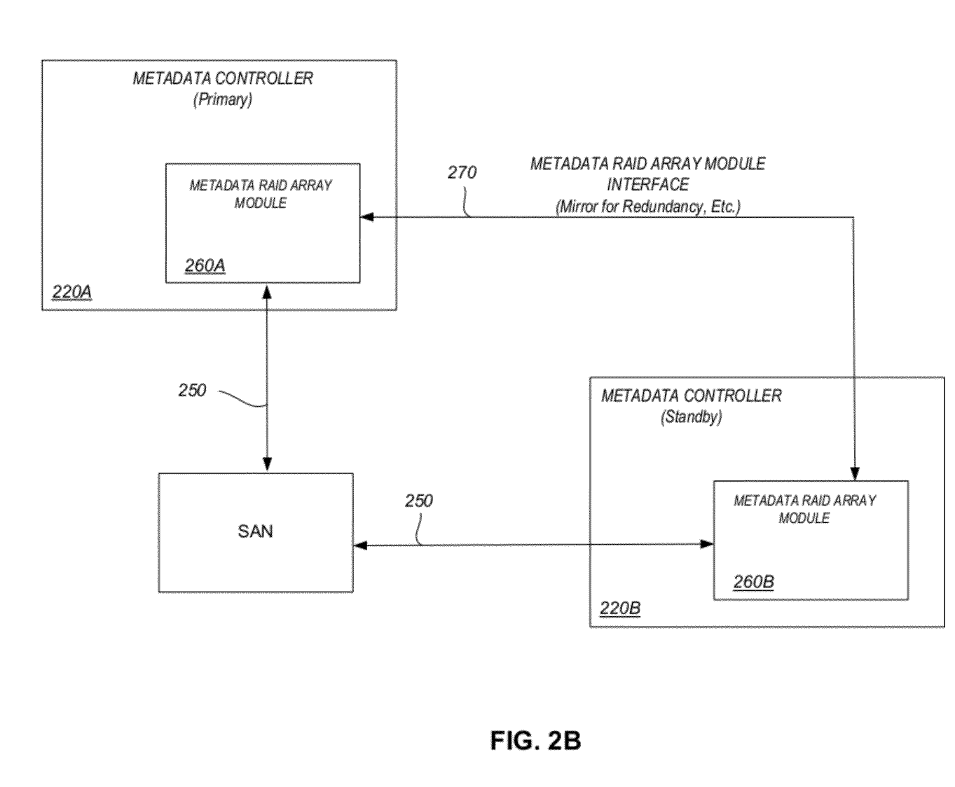

Attention is now directed to FIGS. 2A and 2B. FIG. 2A illustrates an embodiment of a RAID system 200 in accordance with the present invention. In system 200, metadata RAID array functionality as provided by, for example, metadata RAID array 140 as shown in FIG. 1 is provided in a novel modular configuration. In particular, one or more modules are configured to be incorporated in or associated with metadata controllers, which are shown as metadata controllers 220A and 220B of FIG. 2A. These modules are shown is FIG. 2A as metadata RAID array raid modules 260A and 260B. In various embodiments, one or more modules 260 may be configured to be substantially independent from the data bus architecture of the host controller 220A or 220B so that they use the host in a parasitic fashion, i.e., primarily for power and cooling.

As shown in FIG. 2B, the modules 260A and 260B may be interconnected via a module interface 270. In this configuration, modules 260 may provide advantages in the form of an embedded storage solution that is installable within either or both of the host controllers 220A and 220B. This may allow for providing direct accessibility to a user's application data through one or more external interfaces and not through one or more interface buses of the host controllers 220A and 220B. The application data may be further distributed between modules 260A and 260B, providing data redundancy and support for automatic failover.

In an exemplary embodiment, modules 260A and 260B may be implemented as a pair of printed circuit board assemblies, also referred to herein as “Cards” for brevity. The pair of cards may be interconnected via a standard communications channel (e.g., Ethernet, serial line or Fibre Channel) as a backplane between the two controllers 220A and 220B. In accordance with some embodiments, one or more of the Cards may monitor the status(es) of the other Card(s) via a heartbeat message that is transferred over the communications channel. The heartbeat message enables one Card to recognize that is has lost its connection to the other Card. Often, a loss of connection can be the result of the other Card failing or otherwise going offline.

The Cards may be further interconnected with one or more external network devices (e.g., a client computer) via a network interface 250. Such a network interface 250 allows each of the Cards to communicate with the one or more external network devices under various circumstances, including when one Card fails and the other Card is needed to provide metadata (or other data) to the network device(s).

The Cards may be configured mechanically with a frame/chassis configured for insertion in the host metadata controller 220. The mechanical configuration will typically be particular to the architecture and interfaces provided by the host controller 220 (i.e., server or other computer module interfaces—IBM, Apple, Sun, etc.).

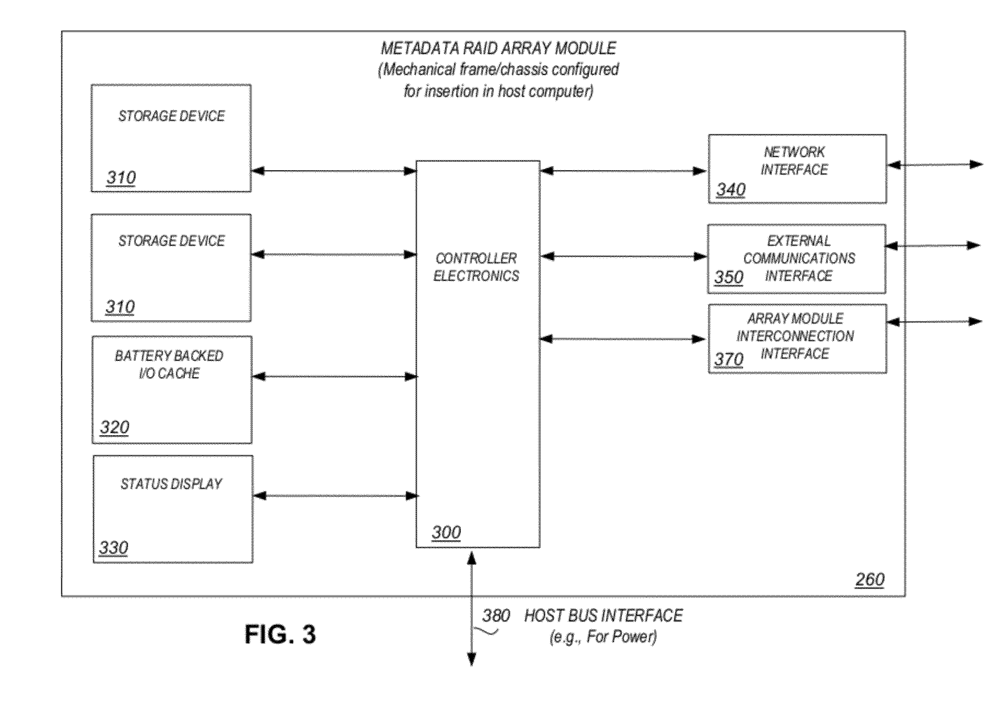

FIG. 3 illustrated details of elements of a module 260 in the form of a Card. The Card may contain a storage mechanism for storage of a user's application data. This may be in the form of one or more storage devices 310 as shown in FIG. 3. The Card may be configured to install in the host device (e.g., controller 220 or other computing device within the scope and spirit of the invention) using the host's standard interface bus to receive power as well as communication capability with the host device. The Card may further be configured to receive cooling from the cooling system of the host device. Example power bus configurations that may be used are PCI, PCI-X, PCI-Express, PC/104 as well as others known or developed in the art.

The Card may optionally provide data redundancy at a single Card level using a RAID mirror. Protection against failure of the Card or the host device may be provided by mirroring data via a standard communication interface to a another Card installed in a second host device—e.g., Cards as shown as modules 260A and 260B of FIG. 2B and installed in host devices such as controllers 220A and 220B, respectively.

Administration of the Card may be done through the host device's standard interface bus (e.g., bus 380), or through another connection (e.g., via interfaces 340, 350 or 370).

As shown in FIG. 3, an embodiment of a Card implementing functionality of module 260 includes two storage devices 310 for providing card-level redundancy. These may be in the form of on-board storage hard drives, solid-state drives, compact flash drives or other storage devices known or developed in the art. In addition, the Card may include a network interface module 340 (e.g., configured to interface via interfaces such as ethernet, serial interfaces or other interfaces). In some embodiments, network interface module 340 may be omitted if the Card is configured to communicate via a host bus interface, such as the bus interface 380. The Card may also include an external communications interface module 350 (e.g., iSCSI, SAS, fiber over ethernet or others). The Card may also include an inter-Card interface module 370. In an exemplary embodiment, this may be a point-to-point Fibre Channel interface, however it could alternately be implemented via a different high-speed or any-speed communications interface.

Controller electronics 300 are included to manage operation of the Card and its various elements. In an exemplary embodiment, a Card is configured as a PCI express card that is consistent with the standard size, power and cooling requirements of PCI express card(s). The electronics are configured to facilitate interfacing with the host bus 380 for administration functions, while providing an embedded configuration for managing the various modules as are shown in FIG. 3, as well as other elements known in the art that are omitted for clarity.

The Card may also include a battery backed I/O cache module 320 as part of the RAID implementation to facilitate caching of RAID data, as well as a status display 330 that may be used to provide status information, fault detection information, and/or other status or operational information.

Access to the Card may be provided through the external communications interface 350. In an exemplary embodiment, this may be a Fibre Channel interface, however, other interfaces, including fiber over Ethernet, iSCSI, SAS, or other standard communication protocols may be used.

As noted previously, administration, such as configuration, fault detection, or other administrative functions, may be performed via the host device interface 380 or through the network interface 340.

The interconnection interface or backplane interface 370 may be used to connect two Cards together. This may be done via a standard or custom communications interface. Example interfaces include Ethernet, Fibre channel IEEE 1394, high speed serial interfaces and the like. By connecting two cards together, the data may be mirrored between the two cards to provide additional data redundancy. The minoring may be done in a fashion as is known or developed in the art.

Certain embodiments of FIGS. 2B and 3 include two host devices designated as Metadata Controllers (MDC's), a Primary MDC and a backup/Secondary MDC. These MDC's write metadata information about the file system onto a small, dedicated Metadata module (e.g., comprising at least part of a PCI express card) in place of writing that metadata on a primary RAID system that is structurally separate from the MDC's. In this configuration, client computing devices may have access to storage on the dedicated PCI express card internal to the MDC, thereby freeing up valuable storage, storage controller bandwidth and CPU cycles on the primary RAID storage.

Certain embodiments of FIGS. 2B and 3 include two or more MDC's, each with one or more Metadata modules. A Metadata module on one MDC may sync all or a part of its stored Metadata to a second Metadata module on the same MDC or different MDC, which provides seamless failover should one MDC or Metadata module fail, thereby enabling a storage network to experience failure of a device while preserving data.

Certain embodiments of FIGS. 2B and 3 include a Metadata module comprising at least part of a PCI express (PCIe) card that is installable in a MDC (e.g., an Xserve with a PCIe slot). The PCIe card may contain a processor, one or two 2.5″ 7200 RPM SATA drives, non-volatile memory, two fibre channel ports, and cache memory. One fibre channel port of each card may provide fibre connectivity to a network of external computing devices that may access the Metadata on the PCIe card. The other fibre channel port may be connected to one or more other PCIe cards, each with a Metadata module that stores a redundant version of the Metadata. The fibre interconnect between the PCIe cards provides in-band management and data synchronization.

Certain embodiments of FIGS. 2B and 3 include a Metadata module comprising at least part of a PCI express (PCIe) card that conforms to tight form-factor requirements. In one embodiment, the PCIe card(s) use a 2.5-inch height hard drive of the highest capacity available. Power may be provided to the PCIe card through a PCIe bus. In some embodiments, a small battery may be required to flush a cache on the PCIe card, but the battery may be removed or omitted. A PCIe card fence may contain several status LEDS or an LCD display. Inclusion of status LEDS or LCD display may be dependent on the processing power and available space on the PCIe card. Design of a PCIe card may take into consideration design for manufacture and test methodologies. Other embodiments may include PCIe cards that consume no more than 25 W at periods of peak power consumption or PCIe cards that use power from inside or outside the host system. Other embodiments may deliver RAID 1 or 0 from two onboard 2.5-inch SATA drives (e.g., 7200 RPM, 5400 RPM). In accordance with certain embodiments, drives may be replaceable, memory for file copies may be delivered in flight via standard industry DIMM modules that may be replaceable. In other embodiments, the PCIe cards may be formed to fit within the Slot 2 requirements of Intel-based Apple Xserves (e.g., a 9-inch length), or the PCIe cards may accommodate at least 2 4 Gb FC ports (e.g., one to participate in the network and another for mirroring operations with a second PCIe card). In accordance with some embodiments, heatsinks may accommodate or integrate with an aluminum shroud fastened to a PCIe card that will allow a graphic or brand treatment, an HW emulator may be used in association with a PCIe card, or a diagnostic mode that may be removed, disabled, or hidden on shipping units may be used in association with a PCIe card.

Certain embodiments of FIGS. 2B and 3 include an embedded operating system providing Serial Advanced Technology Attachment (SATA) and Fibre Channel drivers, as well as support for a RAID 1 raid stack or controller. Several processes may operate on one or more processors or like devices to manage any or all of the Card(s) and to maintain synchronization between/among multiple Cards. Management software may be run on the processors, or may be provided through any of the interfaces of the Card. By way of example, management software may map a card's low-level application programming interface (API) to one or more software suites that allow for the installation and setup of a Card in a host device, the syncing of two or more Cards, and the seamless integration of a Card to one or more external devices in a SAN.

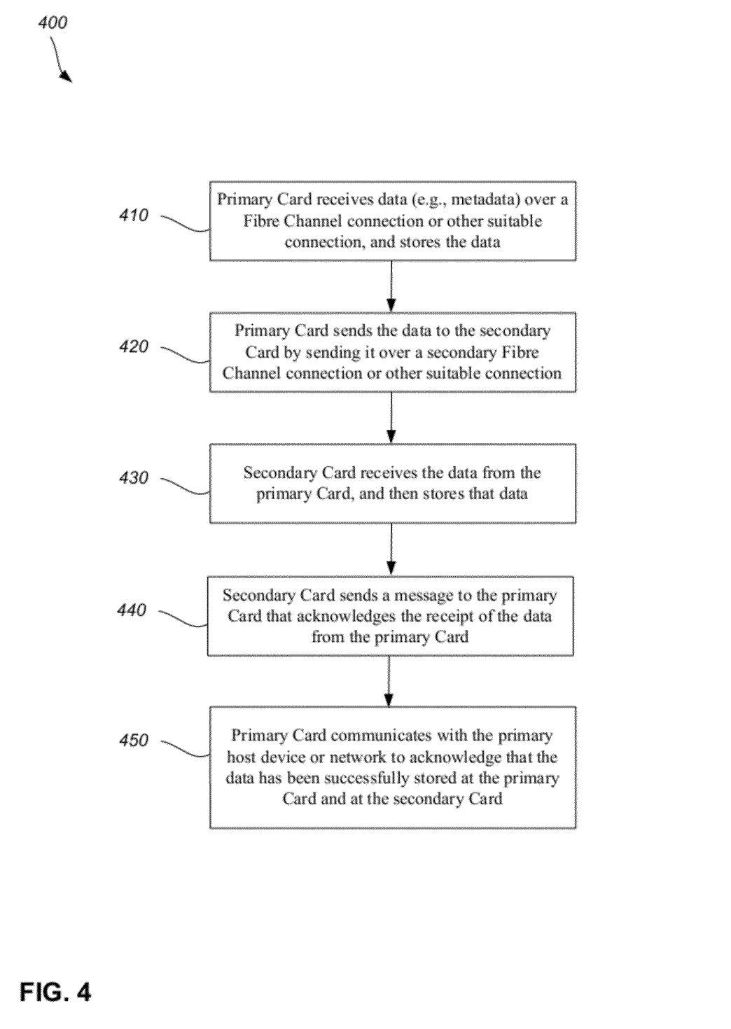

FIG. 4 depicts a process flow 400 for mirroring information from a primary Card of a primary host device onto another Card of a secondary host device in accordance with certain embodiments of the present invention. At block 410, the primary Card receives data (e.g., metadata) over a Fibre Channel connection or other suitable connection, and also stores the received data on one or more local, mirrored disk drives or other suitable storage technology. For example, the data may be stored in a RAID-1 configuration. At block 420, the primary Card sends the data to the secondary Card by sending it over a secondary Fibre Channel connection or other suitable connection. At block 430, the secondary Card receives the data from the primary Card, and then stores that data on one or more local, mirrored disk drives of suitable storage technology. For example, the data may be stored in a RAID-1 configuration. At step 440, the secondary Card sends a message, to the primary Card, that acknowledges the receipt of the data from the primary Card. At step 450, the primary Card communicates with the primary host device to acknowledge that the data has been successfully stored at the primary Card and at the secondary Card.

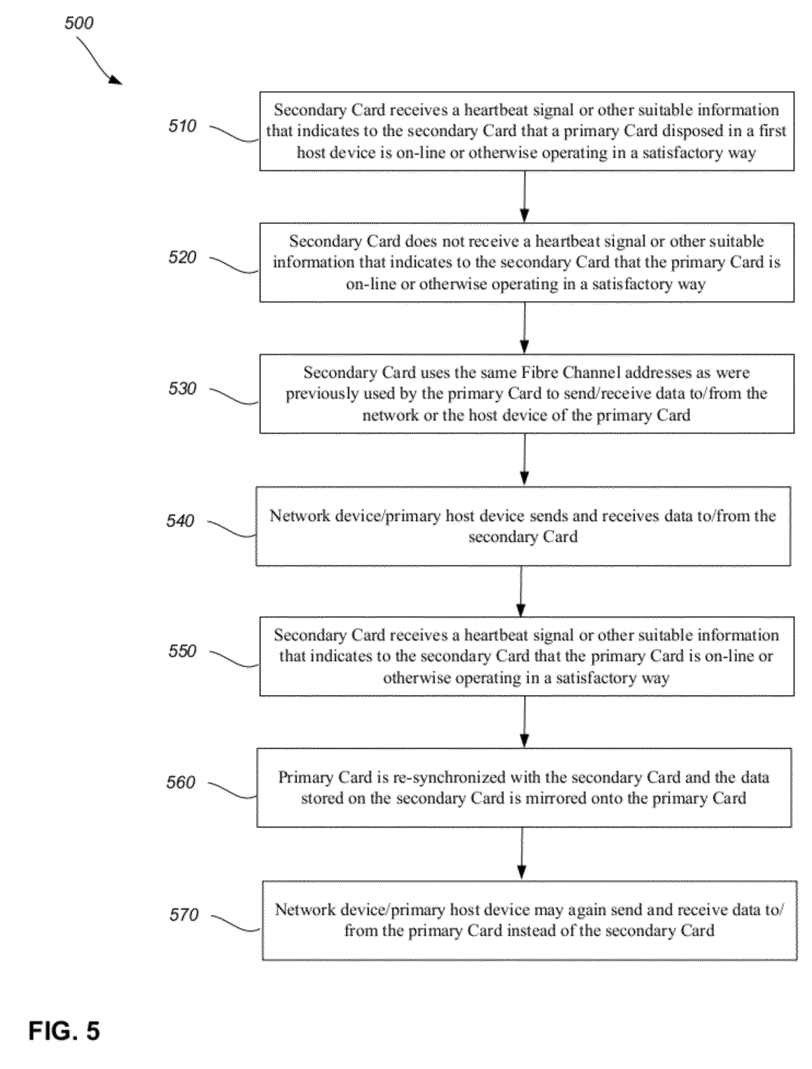

FIG. 5 depicts a process flow 500 for failover operations in accordance with certain embodiments of the present invention. At block 510, a secondary Card receives a heartbeat signal or other suitable information that indicates to the secondary Card that a primary Card disposed in a first host device is on-line or otherwise operating in a satisfactory way. Under such conditions of operation, the network may send and receive data to/from the primary Card. At block 520, the secondary Card does not receive a heartbeat signal or other suitable information that indicates to the secondary Card that the primary Card is on-line or otherwise operating in a satisfactory way. At block 530, the secondary Card uses the same Fibre Channel addresses as were previously used by the primary Card to send/receive data to/from a network device or the host device of the primary Card. At block 540, a network device/primary host device sends and receives data to/from the secondary Card. At block 550, the secondary Card receives a heartbeat signal or other suitable information that indicates to the secondary Card that the primary Card is on-line or otherwise operating in a satisfactory way. At block 560, the primary Card is re-synchronized with the secondary Card and the data stored on the secondary Card is minored onto the primary Card. Synchronization and mirroring may be accomplished using a manual or automated technique known in the art. For example, a process similar to that described above in relation to the process 400 of FIG. 4 may be used to mirror data from the secondary Card to the primary Card. In order initiate the synchronization and mirroring process, an initiation signal may be sent to either or both of the Cards over a bus, the Fibre Channel or other suitable connection. After the primary Card is re-mirrored and re-synchronized at blcok 560, the network may again send and receive data to/from the primary Card instead of the secondary Card at block 570.

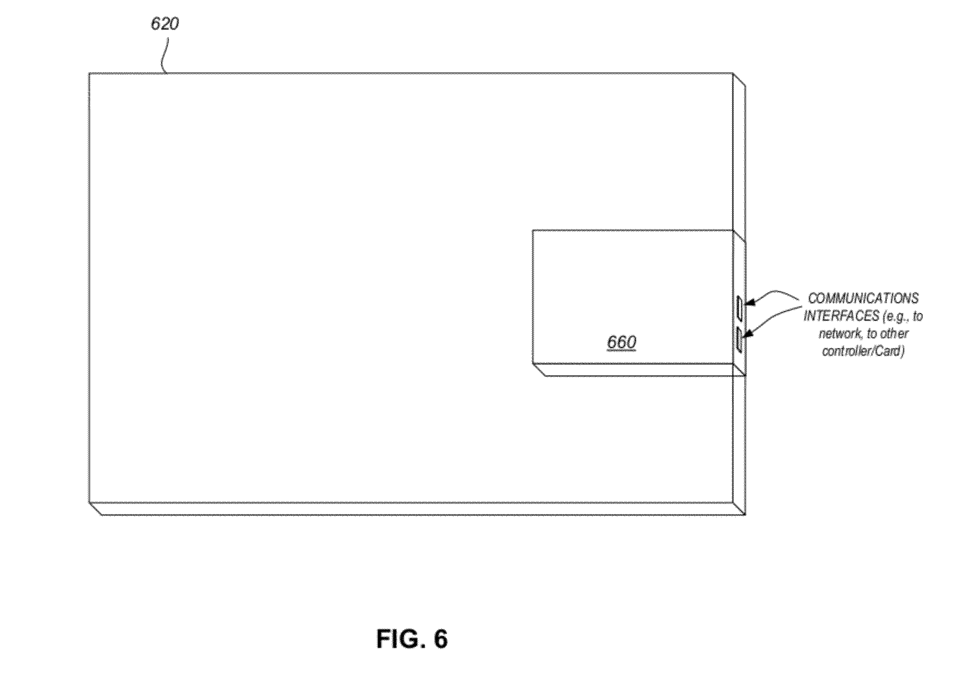

FIG. 6 illustrates an embodiment of a metadata server 620, which may correspond with controllers 220A and 220B of FIG. 2B. For example, metadata server 620 is may be an Apple Xserve system or other suitable system. A Card 660, which may correspond with modules 260A and 260B of FIG. 2B, is disposed within the metadata server 620. As shown, the Card 660 may include one or more interfaces for communication with network devices and/or other Cards or metadata servers.

Any of the embodiments described above may be used in relation to various SAN environments. In accordance with one environment, the various embodiments of the invention may be used in place of a typical RAID system that stores Medatata information. In accordance with another environment, the various embodiments of the invention may be used in addition to a typical RAID system. In accordance with yet another environment, the various embodiments of the invention may be used with a portion of the typical RAID system.

Based on the teachings herein one skilled in the art should appreciate that an aspect disclosed herein may be implemented independently of any other aspects and that two or more of these aspects may be combined in various ways. For example, a system or sub-system may be implemented, or a method may be practiced using any number of the aspects set forth herein. In addition, such a system may be implemented or such a method may be practiced using other structure, functionality, or structure and functionality in addition to or in place of one or more of the aspects set forth herein. Furthermore, an aspect may comprise one or more elements of a claim.

In some configurations, the systems and methods for mirroring processes and failover processes described herein include means for performing various functions as are described herein. In one aspect, the aforementioned means may be a processor or processors and associated memory in which embodiments of the invention reside, and which are configured to perform the functions recited by the aforementioned means. Such processors may be implemented within the controller electronics 300 of FIG. 3, or are not shown in FIG. 3 but are in communication with the various elements 300-380 of FIG. 3. Alternatively, such processors may be implemented within the controllers 220 of FIG. 2B, or within the various elements 110, 130, 140, 150 or other elements not shown in FIG. 2A. The aforementioned means may comprise any portion of a device or any number of devices configured to perform the functions recited by the aforementioned means.

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media such as was described previously herein. Storage media may be any available media that can be accessed by a computing device. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computing device. By way of example, the medium may be a stand-alone storage device not shown in communication with any of the elements in FIGS. 2A, 2B and 3, a storage device not shown that is embedded within any of the elements in FIGS. 2A, 2B and 3, or all or a portion of storage devices 310. These instructions may be provided in the form of an application program and/or a plug-in to an application program. In some embodiments, the application program or plug-in may be provided in a downloadable format, such as via a webpage or other downloading mechanism. Disk and disc, as used herein, includes compact disc (CD), laser disc, optical disc, digital versatile disc (DVD), floppy disk and blu-ray disc, where disks usually reproduce data magnetically, while discs reproduce data optically with lasers. Combinations of the above are also be included within the scope of computer-readable media.

It is also understood that the specific order or hierarchy of steps in the processes disclosed are each exemplary approaches. Based upon design preferences, it is understood that the specific order or hierarchy of steps in the processes may be rearranged while remaining within the scope of the present disclosure. Accordingly, the accompanying method claims present elements of the various steps in a sample order, and are not meant to be limited to the specific order or hierarchy presented.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, DSP or state machine. A processor may also be implemented as a combination of computing devices (e.g., a combination of a DSP and a microprocessor, a plurality of microprocessors, one or more microprocessors in conjunction with a DSP core, or any other such configuration).

Those of skill in the art would understand that information and associated data files and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

We claim:

1. An embedded module for a RAID system, comprising:
a frame configured for insertion in a host device; and
an electronics module coupled to the frame, the electronics module including:
a host bus interface configured to receive power from the host device;
one or more storage devices;
an external communications interface configured to provide access to the storage devices from a client computer through an external communications network; and
controller electronics configured to manage the host bus interface, the one or more storage devices and the external communications interface.

2. The embedded module of claim 1, further including an array module interconnection interface configured to communicatively couple the embedded module with a second embedded module so as to mirror a set of data stored on the one or more storage devices.

3. The embedded module of claim 1, further including a battery backed I/O cache.

4. The embedded module of claim 1, further including a status display.

5. The embedded module of claim 1, further including a network interface.

6. The embedded module of claim 1, wherein the one or more storage devices comprise a hard disk drive.

7. The embedded module of claim 1, wherein the one or more storage devices comprise a solid state storage device.

8. The embedded module of claim 1, wherein the array module interconnection interface is a Fibre Channel interface.

9. The embedded module of claim 1, wherein the external communications interface is a Fibre Channel interface.

10. The embedded module of claim 5 wherein the network interface is an Ethernet interface.

11. A method of managing storage for a RAID system, the method comprising:
receiving, at a first metadata controller, a request from a client computer for access to data on an external RAID array;
retrieving, from a first metadata RAID array module associated with the metadata controller, metadata associated with the client computer request; and
providing the metadata from the metadata controller to the client computer.

12. The method of claim 11, further comprising:
mirroring the metadata to a second metadata RAID array module disposed in a second metadata controller.

13. The method of claim 11, wherein the first metadata RAID array module is disposed in the first metadata controller.

14. The method of claim 13, wherein metadata is associated with data stored on the external RAID array.

15. A method of managing storage for a RAID system using a metadata RAID array module associated with a metadata controller, the method comprising:
receiving, via an external communications interface, a request for metadata; and
providing, responsive to the request for metadata, one or more sets of metadata from a storage device disposed in the metadata RAID array module.

16. The method of claim 15, further comprising mirroring the sets of metadata to a second metadata RAID array module disposed in a second metadata controller.

17. The method of claim 16, wherein the metadata is associated with data stored on an external RAID array.

18. A method of mirroring data, the method comprising:
receiving metadata at a first metadata RAID array module disposed in a first metadata controller;
storing the metadata at the first metadata RAID array module;
sending a copy of the metadata from the first metadata RAID array module to a second metadata RAID array module disposed in a second metadata controller; and
receiving, at the first metadata RAID array module, one or more messages from the second metadata RAID array module, wherein the one or more messages indicate whether the second metadata RAID array module received the copy of the metadata.

19. The method of claim 18, further comprising:
receiving the copy of the metadata at the second metadata RAID array module; and
storing the copy of the metadata at the second metadata RAID array module.

20. The method of claim 18, wherein the metadata is received over a first Fibre Channel interface and the copy of the metadata is sent over a second Fibre Channel interface.

21. The method of claim 18, further comprising:
sending, from the first metadata RAID array module to the second metadata RAID array module, information indicating whether the first metadata RAID array module is functional.

22. A method of failover in a RAID system, the method comprising:
receiving, at a second metadata RAID array module disposed in a second metadata controller, status information relating to a first metadata RAID array module disposed in a first metadata controller;
determining, based upon the status information, that the first metadata RAID array module is not functional; and
receiving, at the second metadata RAID array module, a request for data from a client device of the RAID system.

23. The method of claim 22, further comprising:
controlling the second metadata RAID array module to use a routing address that was previously used by the first metadata RAID array module.

24. The method of claim 22, wherein the status information is conveyed using a heartbeat signal received from a Fibre Channel interface.

25. The method of claim 22, further comprising:
receiving, at the second metadata RAID array module, additional status information relating to the first metadata RAID array module;
determining, based upon the additional status information, that the first metadata RAID array module is functional; and
receiving, at the second metadata RAID array module, a request for data from the first metadata RAID array module.

26. The method of claim 25, further comprising:
sending, based upon the request for data from the first metadata RAID array module, metadata from the second metadata RAID array module to the first metadata RAID array module; and
receiving, at the second metadata RAID array module, one or more messages from the first metadata RAID array module, wherein the one or more messages indicate whether the first metadata RAID array module received the metadata.
